(19) United States
(12) Patent Application Publication
(10) Pub. No.: US 2010/0255737 A1
(43) Pub. Date: Oct. 7, 2010

(54) OUTBOARD MOTOR

(75) Inventor: Takeshi Inaba, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 12/607,601

(22) Filed: Oct. 28, 2009

(30) Foreign Application Priority Data
Dec. 11, 2008 (JP) 2008-316033

(51) Int. Cl. F02M 35/12

(52) U.S. Cl. 440/88 A

(57) ABSTRACT

An outboard motor has a top cover extending over an engine cover covering an engine, and an upstream intake silencer spaced upward apart from the top wall of the engine cover. The upstream intake silencer has an entrance duct spaced apart from the top wall and forming an inlet air passage through which air for combustion flows from an air-intake space into the upstream intake silencer. The upstream end of the inlet air passage is on the rear side of the downstream end of an outlet air passage and at a level above that of an air-intake opening. The entrance duct does not extend downward from a bottom wall forming the upstream expansion chamber and protrudes upward from the bottom wall in the upstream expansion chamber.

### BACKGROUND OF THE INVENTION

1. Field of the Invention

The present invention relates to an outboard motor including an internal combustion engine provided with an intake system for carrying air for combustion, namely, intake air, into a combustion chamber, an engine cover forming an engine compartment in which the internal combustion engine is placed, a top cover covering the engine cover from above, and an intake silencer.

2. Description of the Related Art

A known outboard motor disclosed in, for example JP 5-286490 A, JP 2006-151242 and U.S. Pat. No. 3,610,198 includes an internal combustion engine provided with an intake system for carrying intake air for combustion into a combustion chamber, an engine cover forming an engine compartment in which the internal combustion engine is placed, a top cover covering the engine cover from above. In this outboard motor, intake air taken into an air-intake space defined by the engine cover and the top cover is carried into the intake system disposed in the engine compartment.

When the intake system disposed within the engine compartment of the outboard motor opens into the air-intake space outside the engine compartment, cool intake air can be taken into the intake system, as compared with a case in which intake air is taken into the engine compartment and warmed by heat radiated from the engine in the engine compartment. Thus, the internal combustion engine can be charged at an improved charging efficiency and the output performance of the engine can be improved when such intake air at lowered temperature is taken into the intake system.

When the intake system opens into the air-intake space outside the engine compartment, the intake pulsation caused by the internal combustion engine is transmitted through the intake system to the air-intake space. Since the air-intake space is defined by the top cover and the engine cover, the engine cover is vibrated by the intake pulsation transmitted to the air-intake space to generate noise.

When an air-intake passage connecting an air-intake opening into the air-intake space to the intake system is formed in a labyrinthine shape to prevent water collected in the air-intake space from flowing into the intake system, intake resistance increases to deteriorate the output performance of the internal combustion engine.

### SUMMARY OF THE INVENTION

The present invention has been made in view of such problems and it is therefore a principal object of the present invention to reduce noise generated by the engine cover which is vibrated by intake pulsation transmitted to the air-intake space through the intake system in the engine compartment formed by the engine cover, to increase the degree of freedom of designing the engine cover forming the air-intake space, and to form the outboard motor in small vertical dimensions by disposing the intake silencer close to the engine cover.

Another object of the present invention is to restrain water from mixing into the intake air and to improve the output performance of the internal combustion engine by properly arranging the inlet, the outlet and the throttle passage of the intake silencer.

To attain the objects, the present invention provides an outboard motor comprising: an internal combustion engine; an intake system for carrying intake air for combustion into a combustion chamber formed in the internal combustion engine; an engine cover forming an engine compartment for enclosing the internal combustion engine; and a top cover covering the engine cover from above:

wherein the outboard motor includes an air-intake opening formed outside the engine compartment, and an intake silencer for carrying intake air taken in through the air-intake opening into the intake system, the intake system being disposed within the engine compartment;

wherein the intake silencer is disposed outside the engine compartment, is spaced apart from the engine cover such that an air-intake space connecting to the air-intake opening is formed between a top wall of the engine cover and the intake silencer; and

the intake silencer has an entrance duct spaced apart from the top wall and having an upstream end through which intake air flows from the air-intake space into the entrance duct, a wall structure defining an expansion chamber into which intake air flows through the inlet air passage, and an exit duct forming an outlet air passage through which intake air flows from the expansion chamber into the intake system; and

wherein the inlet air passage has an upstream end opening into the air-intake space, and is on a rear side of a downstream end of the outlet air passage and at a level higher than that of the air-intake opening; and

the entrance duct does not extend downward from a bottom wall included in the wall structure defining the expansion chamber and extends upward from the bottom wall in the expansion chamber.

In the outboard motor of the present invention, the pulsation of intake air in the intake system disposed in the engine compartment is attenuated by the upstream intake silencer disposed outside the engine compartment, and the upstream intake silencer is spaced apart from the engine cover by the air-intake space. Therefore, the pulsation of intake air transmitted from the intake system to the air-intake space is suppressed and hence noise resulting from the vibration of the engine cover defining the air-intake space is reduced.

The inlet air passage of the upstream intake silencer opening into the air-intake space is on a rear side of the outlet air passage and hence the inlet air passage is apart from the engine operator in front of the outboard motor. Therefore, the level of intake noise leaking through the inlet air passage is attenuated before the intake noise reaches the engine operator.

The inlet air passage is at a level higher than that of the air-intake opening and the entrance duct is spaced apart from the engine cover. Therefore, restrictions placed by the entrance duct on designing the shape of the top wall of the engine cover defining the air-intake space so as to ensure satisfactory draining of water from the air-intake space are reduced and hence the degree of freedom of designing the top wall increases. Since the entrance duct extends upward in the upstream expansion chamber, the intake silencer can be disposed close to the engine cover with respect to the vertical direction and hence the vertical dimension of the outboard motor can be reduced.

In a preferred mode of the present invention, the intake system is provided with a downstream intake silencer into which intake air flows through the outlet air passage, the downstream intake silencer has a downstream expansion chamber, a vertically extending inlet air passage opening into an upper part of the downstream expansion chamber, and a horizontally extending outlet air passage formed above a bottom wall forming the downstream expansion chamber, the downstream expansion chamber has a lower extension extending to a level below that of the outlet air passage, and a horizontal water-stopping rib is disposed between the lower extension and the outlet air passage.

Since the downstream expansion chamber has the lower extension extending to a level below that of the horizontal outlet air passage, water flowing into the downstream expansion chamber together with intake air flowing vertically downward into the downstream expansion chamber flows by inertia toward the lower extension and adheres to the bottom wall, and the downstream expansion chamber is provided with the water-stopping rib, water is restrained from flowing into the outlet air passage.

In another preferred mode of the present invention, the intake system is provided with a throttle valve device forming a throttle passage connecting to the outlet air passage, and the inlet air passage, the outlet air passage and the outlet air passage are extended so as to intersect a straight line intersecting the inlet air passage and the throttle passage in a plane.

Thus, the flow of intake air through the inlet air passage, the outlet air passage and the inlet air passage into the throttle passage, i.e., the flow of intake air through the upstream and downstream intake silencers, is restrained from horizontal meandering and intake air flows smoothly without meandering horizontally. Consequently, intake resistance is low, and the volumetric efficiency and output performance of the internal combustion engine are improved.

Preferably, the air-intake opening opens rearward at the rear end of the air-intake space, and a rib is formed on the top wall so as to protrude upward from the top wall in the air-intake space and to extend on right, left and rear sides of the upstream end of the inlet air passage.

The rib protruding upward from the top wall of the engine cover and extending on the rear side of the upstream end of the inlet air passage prevents water leaking into the air-intake space from flowing into the inlet air passage. Thus, water is restrained from entering the upstream intake silencer.

The air-intake opening may extend on right, left and rear sides of the upstream intake silencer.

Since the air-intake opening thus extends on the right, left and rear sides of the upstream intake silencer, the air-intake opening has a long circumference. Therefore, the air-intake opening can be formed in a small width while the air-intake opening ensures taking external air in at a necessary intake rate, and the effect of the air-intake opening on suppressing the entrance of water and foreign maters into the air-intake space can be ensured. Since water that has entered the air-intake space is drained laterally from the air-intake space, water is prevented from entering through the air-intake opening into the upstream intake silencer.

### BRIEF DESCRIPTION OF THE DRAWINGS

FIG. 1 is a side elevation of an outboard motor in a preferred embodiment of the present invention taken from the right side of the outboard motor;

FIG. 2 is a side view, in vertical section, of an engine cover, a top cover and an intake silencer included in the outboard motor shown in FIG. 1, in which part of an internal combustion engine as viewed from the right is shown;

FIG. 3 is a sectional plan view taken on the line III-III in FIG. 2; and

FIG. 4 is a sectional view of an essential part of the outboard motor sown in FIG. 1 taken on the line IV-IV in FIG. 2.

### DESCRIPTION OF THE PREFERRED EMBODIMENTS

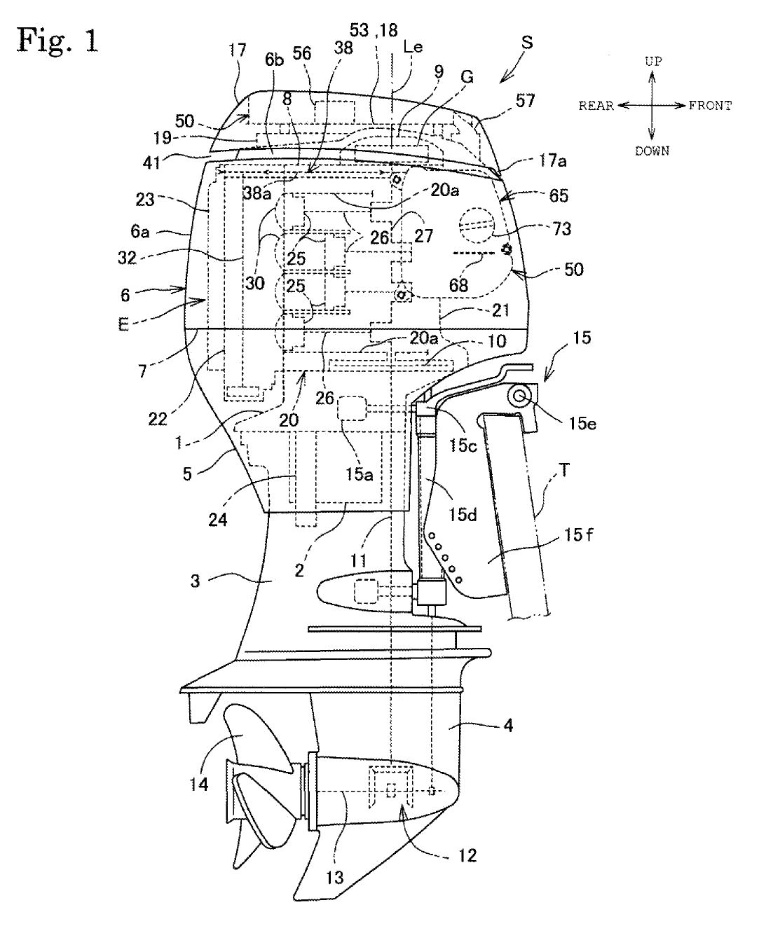

An outboard motor S in a preferred embodiment of the present invention will be described with reference to FIGS. 1 to 4.

Referring to FIG. 1, the outboard motor S to which the invention is applied includes an internal combustion engine E provided with a vertical crankshaft 27 having a vertical center axis Le, namely a vertical combustion engine, an engine mount 1 supporting the internal combustion engine E, an extension case 3 surrounding an oil pan 2 joined to the lower end of the engine mount 1 and joined to the lower end of the engine mount 1, a gear case 4 joined to the lower end of the extension case 3, an under cover 5 covering a part of the outboard motor S between a lower part of the engine E and the upper end of the extension case 3, and an engine cover 6 joined to the upper end of the under cover 5 and covering the internal combustion engine E from above. The engine cover 6 has a side wall 6a disposed around the center axis Le, and a top wall 6b extending over the internal combustion engine E. The internal combustion engine E is held in an engine compartment 7 defined by the under cover 5 and the engine cover 6.

In the specification and claims, directions designated by vertical directions, longitudinal directions and lateral directions correspond to vertical directions, longitudinal directions and lateral directions with respect to the hull T of the boat. As shown in FIG. 1, a direction parallel to the center axis Le of the crankshaft 27 is the vertical direction, and the longitudinal directions and the lateral directions are in a horizontal plane perpendicular to the center axis Le. Upward and downward directions are parallel to the vertical center axis Le, forward and rearward directions are parallel to one of the longitudinal directions and the other longitudinal direction, respectively. Rightward and leftward directions are one of the lateral directions and the other lateral direction, respectively. Viewing in a plane means viewing from a vertical direction or a direction parallel to the center axis Le. A circumferential direction is parallel to a circumference about the center axis Le unless otherwise specified.

A transmission included in the outboard motor S includes a drive shaft 11 connected to the lower end of the crankshaft 27, namely, an output shaft, a flywheel 10 fixedly mounted on the drive shaft 11, a forward-rearward change gear 12 contained in the gear case 4, and a propeller shaft 13 holding a propeller 14. The output power of the internal combustion engine E is transmitted from the crankshaft 27 through the drive shaft 11, the forward-rearward change gear 12 and the propeller shaft 13 to the propeller 14 to rotate the propeller 14. In this embodiment, the center axis of the drive shaft 11 is aligned with the center axis Le. The center axis of the drive shaft 11 may be parallel to the center axis Le.

A mounting device 15 for holding the outboard motor S on the hull T includes a swivel case 15d fixedly held by mounting rubber cushions 15a on the mount 1 and the extension case 3, a swivel shaft 15c rotatably supported on the swivel case 15d, a tilt shaft 15e supporting the swivel case 15d so as to be turnable thereon, and a transom clamp 15f holding the tilt shaft 15e and fixed to the transom of the hull T. The outboard motor S supported on the hull T by the mounting device 15 is turnable on the tilt shaft 15e in a vertical plane and can turn on the swivel shaft 15c in a horizontal plane.

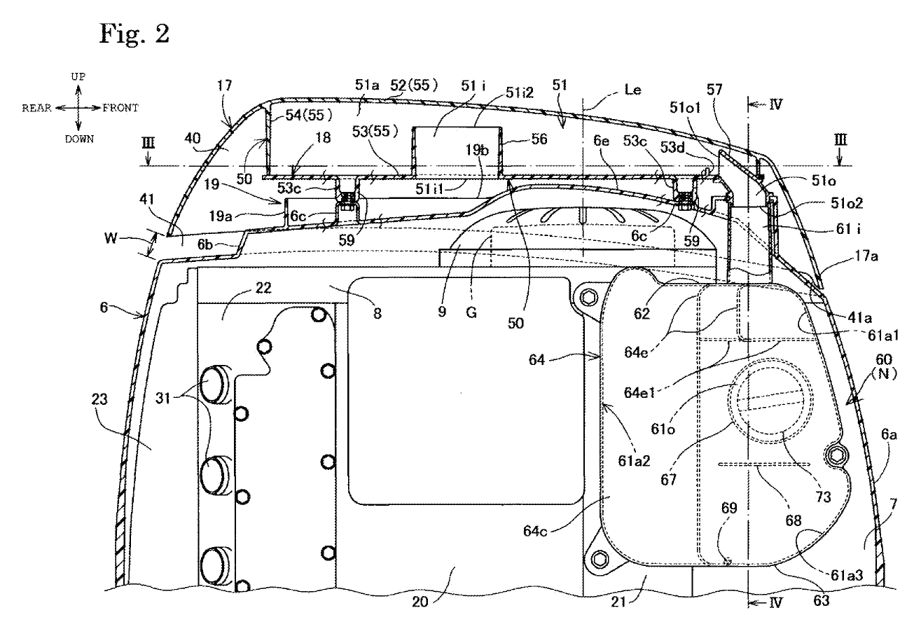

Referring to FIG. 2, the internal combustion engine E is a multiple-cylinder four-stroke-cycle internal combustion engine and has an engine body including a cylinder block 20 provided with four cylinders 20a (FIG. 1) vertically arranged in a row, a crankcase 21 joined to the front end of the cylinder block 20, a cylinder head 22 joined to the rear end of the cylinder block 20, and a valve cover 23 joined to the rear end of the cylinder head 22.

The cylinder head 22 and the valve cover 23 are rear members of the engine body. The crankcase 21 is a front member of the engine body, disposed on the front side of the center axis Le of the crankshaft 27.

As shown in FIG. 11, pistons 25 are fitted in the cylinders 20a, respectively, so as to be axially movable and connected by connecting rods 26 to the crankshaft 27 rotatably supported on the cylinder block 20 and the crankcase 21, respectively. The cylinder head 22 is provided with combustion chambers 30 and bores 31 (FIG. 2) for receiving spark plugs. The combustion chambers 30 are axially opposite to the pistons 25, respectively. The spark plugs fitted in the bores 31 are exposed to the combustion chambers 30, respectively.

Intake valves and exhaust valves are provided respectively for closing and opening intake ports and exhaust ports formed in the cylinder head 22 and open into the combustion chambers 30. The intake valves and exhaust valves are driven for opening and closing operations in synchronism with the rotation of the crankshaft 27 by a camshaft 32 included in an overhead camshaft type valve train disposed in a valve chamber formed by the cylinder head 22 and the valve cover 23. The camshaft 32 is covered with a transmission case 8 (FIG. 2) from above. The camshaft 32 is rotationally driven by the power of the crankshaft 27 through a wrapping transmission mechanism 38 including a belt 38a.

A generator cover 9 covering an alternator G is connected to the transmission case 8. The alternator G is rotationally driven by the crankshaft 27.

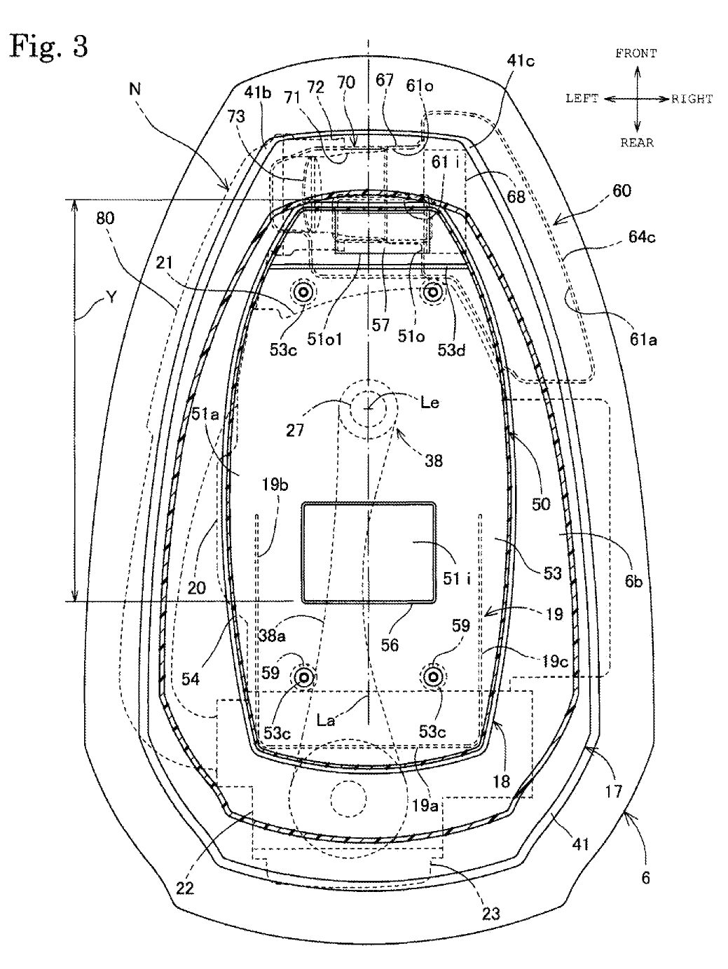

Referring to FIGS. 2 and 3, the internal combustion engine E is provided with an intake system N disposed within the engine compartment 7. The intake system N forms an air-intake passage for carrying intake air for combustion taken therein through an air-intake opening to the combustion chambers 30. Intake air flowing in the air-intake passage is mixed with fuel ejected by a fuel injection valve to form an air-fuel mixture. The air-fuel mixture is ignited by the spark plug and burns in the combustion chamber 30. The piston 25 is driven for reciprocation by the pressure of combustion gas produced in the combustion chamber 30. The piston 25 thus driven rotationally drives the crankshaft 27 through the connecting rod 26. The combustion gas that has worked for driving the piston 25 is discharged as an exhaust gas into an exhaust pipe 24 (FIG. 1). The exhaust gas flows from the exhaust pipe 24 into an exhaust passage, not shown, formed in the extension case 12, the gear case 13 and the boss of the propeller 20 and is discharged from the outboard motor S.

Referring to FIG. 1, the outboard motor S has an upstream intake silencer 50, namely, an air intake device, and a top cover 17. The intake silencer 50 is disposed at a position directly above the engine compartment 7 or the top wall 6b of the engine cover 6 outside the engine compartment 7. The top cover 17 covers the top wall 6b of the engine cover 6 from above. As shown in FIG. 2, the upstream intake silencer 50 forms an air-intake passage 51. Air for combustion flows through the upstream intake silencer 50 into the intake system N.

A space extending under the top cover 17 and the upstream intake silencer 50 and over the top wall 6b is an air-intake space 40 through which air for combustion flows into the air-intake passage 51. Joining parts 6c formed on the top wall 6b and joining parts 53c formed on the upstream intake silencer 50 so as to correspond to the joining parts 6c, respectively, are fastened together with bolts. Parts of the upstream intake silencer 50 other than the joining parts 53c are spaced upwardly apart from the top cover 6b of the engine cover 6 so as to form the air-intake space 40.

An air-intake opening 41 extends circumferentially along the engine cover 6 and the top cover 17. The air-intake opening 41 opens into the air-intake space 40. The air-intake opening 41 has a width W corresponding to the distance between the boundary between the side wall 6a and the top wall 6b, and the lower edge of the top cover 17. A front part 41a of the air-intake opening 41 is covered with a covering part 17a formed by extending a front part of the top cover 17 downward. The front part 41a of the air-intake opening 41 is a small gap or is closed. The front part 17a of the top cover 17 prevents entrance of water coming from the front side of the outboard motor S through the air-intake opening 41 into the air-intake space 40.

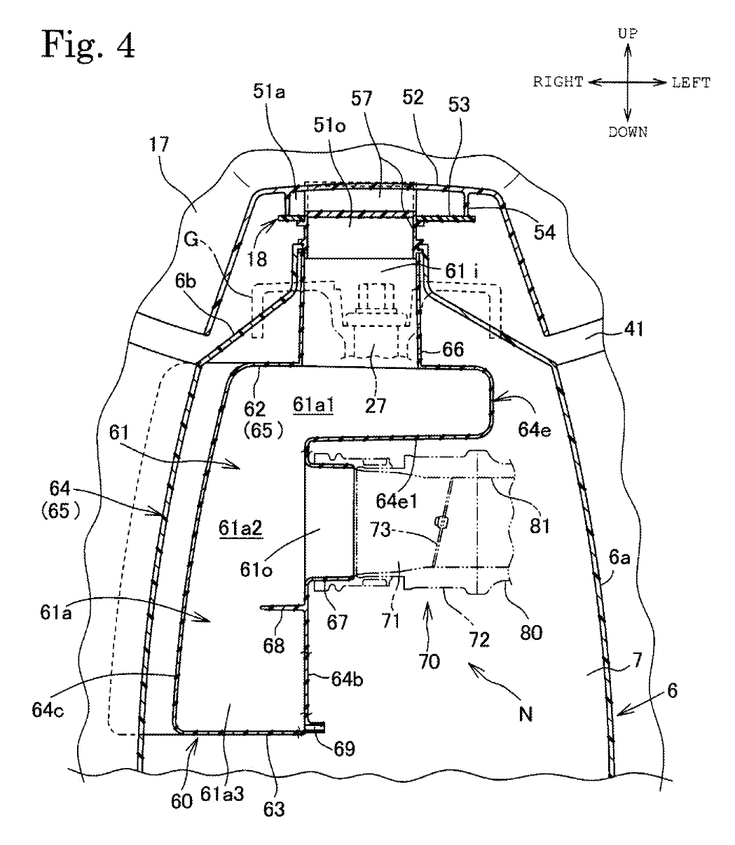

Referring to FIGS. 2 and 4, the upstream intake silencer 50 disposed outside the engine compartment 7 and forming the air-intake passage 51 has a top wall 52, which is a part of the top cover 17, a bottom wall 53 serving as an intermediate cover 18 disposed between the top wall 6b and the top cover 17 with respect to the vertical direction, a vertical side walls 54 formed integrally with the top cover 17 and extending between the top wall 52 and the bottom wall 32, an entrance duct 56 formed integrally with the intermediate cover 18, namely, the bottom wall 53, and an exit duct 57 joined to the intermediate cover 18, namely, the bottom wall 53. The bottom wall 53 vertically spaced apart from the top wall 6b so as to define the air-intake space 40. The entrance duct 56 is separated upward from the top wall 6b.

The air-intake passage 51, through which air for combustion flows into the air intake system N, has an upstream expansion chamber 51a, namely, an inlet air silencing chamber, defined by a wall structure 55 formed of the top wall 52, the bottom wall 53 and the side walls 54, an inlet air passage 51i, defined by the entrance duct 56, and an outlet air passage 51o defined by the exit duct 57. Air flows from the air-intake space 40 through the inlet air passage 51i into the upstream expansion chamber 51a. Air flows from the upstream expansion chamber 51a through the outlet air passage 51o into a downstream intake silencer 60. The sectional area of the upstream expansion chamber 51a into which air flows through the inlet air passage 51i is greater than the respective passage areas of the inlet air passage 51i and the outlet air passage 51o.

The inlet air passage 51i extending upward into the upstream expansion chamber 51a has an upstream end 51i1 opening into the air-intake space 40, and a downstream end 51i2 opening into the upstream expansion chamber 51a. The outlet air passage 510 has an upstream end 51o1 opening into the upstream expansion chamber 51a, and a downstream end 51o2 opening into an entrance duct 66 (FIG. 4).

The entrance duct 56 does not protrude downward from the bottom wall 53 and protrudes upward from the bottom wall 53 into the upstream expansion chamber 51a. The exit duct 57 protrudes from the bottom wall 53 into the upstream expansion chamber 51a. A downstream part of the exit duct 57 is connected to the entrance duct 66 included in the downstream intake silencer 60. The exit duct 57 deflects horizontal air flow in the upstream expansion chamber 51a into vertical flow of air into the entrance duct 66.

The upstream end 51i1 of the inlet air passage 51i opens downward into the air-intake space 40. The upstream end 51o1 of the outlet air passage 51o opens rearward so as to face the entrance duct 56. The inlet air passage 51i and the outlet air passage 51o are spaced apart from each other with respect to the longitudinal direction and are disposed on the opposite sides, respectively, with respect to the center axis Le. The inlet air passage 51i including the upstream end 51i1 are disposed on the rear side of the outlet air passage 51o including the downstream end 51o2. The positional relation between the inlet air passage 51i and the outlet air passage 51o in a plane is shown in FIG. 3.

As shown in FIGS. 2 and 3, a water-stopping rib 53d is formed near the upstream end 51o1 of the outlet air passage 51o and on the rear side of the upstream end 51o1 of the outlet air passage 51o. The water-stopping rib 53d rises from the bottom wall 53. The water-stopping wall 53d prevents water collected on the bottom wall 53d from flowing through the upstream end 51o1 into the exit duct 57.

The air-intake opening 41 is at a level lower than those of the upstream intake silencer 50 having the upstream expansion chamber 51a and the upstream end 51i1 of the inlet air passage 51i. The U-shaped air-intake opening 41 surrounds the rear, right and left sides of the upstream intake silencer 50 or the upstream expansion chamber 51a as viewed in a plane as shown in FIG. 3. Thus, the air-intake opening 41 opens rearward in a rear end part of the air-intake space 40.

The front ends 41b and 41c of the U-shaped air-intake opening 41 are on the front side of the outlet air passage 51o, the center axis Le, the inlet air passage 51i and the upstream intake silencer 50 having the upstream expansion chamber 51a with respect to the longitudinal direction. Therefore, as obvious from FIG. 3, the air-intake opening 41 extends longitudinally on the right and left sides of the upstream end 51i1 of the inlet air passage 51i and the downstream end 51o2 of the outlet air passage 51o beyond the front and rear ends of a range Y in which the upstream end 51i1 and the downstream end 51o2 are arranged. Thus, the air-intake opening 41 extends on the right and left sides of the upstream end 51i1 with respect to the lateral direction, and extends longitudinally from a position corresponding to the cylinder head 22 and the valve cover 23 to a position on the front side of the center axis Le of the crankshaft 27 of the internal combustion engine E.

Therefore, the circumferential length of the air-intake opening 41 surrounding the air-intake space 40 is prolonged and hence air for combustion can be taken in at a necessary intake rate and the width W of the air-intake opening 41 may be small.

Referring to FIGS. 2 to 4, the intake system N forming the air-intake passage for carrying intake air for combustion taken therein through the air-intake opening 41 to the combustion chambers 30 includes the downstream intake silencer 60. The downstream intake silencer 60 extends to the right from a position on the front side of the crankcase 21 in the engine compartment. The intake system N further includes a throttle device 70 disposed on the front side of the crankcase 21 connected to the downstream end of the downstream intake silencer 60 and is provided with a throttle valve 73 controlling air flow and an intake manifold 80 having an upstream end connected to the downstream end of the throttle device 70 and a downstream end connected to the cylinder head 22 provided with the intake ports.

The air-intake passage continuously extending from an inlet air passage 61i to the intake ports has an upstream intake passage 61, a throttle passage 71 provided with the throttle valve 73 and defined by a throttle body 72 included in the throttle device 70, and a downstream intake passage 81 defined by the intake manifold 80 and connected by the throttle passage 71 to the upstream intake passage 61. Air flows from the downstream intake passage 81 through the exit of the air-intake passage into the intake ports. Air is sucked through the intake ports into the combustion chambers 30.

The downstream intake silencer 60 disposed on the downstream side of the upstream intake silencer 50 has a wall structure 65 forming a downstream expansion chamber 61a, the entrance duct 66 forming the inlet air passage 61i, and an exit duct 67 forming an outlet air passage 61o. The wall structure 65 has a top wall 62 connected to the entrance duct 66, a bottom wall 63 below the exit duct 67 and the throttle device 70, and a side wall 64 extending between the top wall 62 and the bottom wall 63. The side wall 64 has a right part 64c and a left part 64b laterally opposite to the right wall 64c. The exit duct 67 projects to the left from the left part 64b.

The upstream intake passage 61 has the downstream expansion chamber 61a, namely, an enlarged chamber serving as an inlet air silencing chamber, the inlet air passage 61i through which air flowing from the air-intake space 40 through the air-intake passage 51 flows into the expansion chamber 61a, and the outlet air passage 610 through which air flows from the expansion chamber 61a into the throttle passage 71. The sectional area of the downstream expansion chamber 61a, into which air for combustion flows from the upstream intake silencer 50 through the inlet air passage 61i, is greater than the respective sectional areas of the inlet air passage 61i and the outlet air passage 61o. The inlet air passage 61i does not open into the engine compartment 7 and communicates with the air-intake space 40.

The downstream expansion chamber 61a has an upper space 61a1 extending over the throttle device 70, and a main space 61a2 extending downward from the upper space 61a1. The upper space 61a1 is defined by the top wall 62 and an upper part of the side wall 64. The upper space 61a1 is defined mainly by the top wall 62, and a projecting part 64e of the left part 64b of the side wall 64. The projecting part 64e extends to the right over the throttle body 71. Thus, the top wall 62, the upper space 61a1, a bottom wall 64e1 defining the bottom of the upper space 64a1 overlie the throttle device 70. The bottom wall 64e1 is disposed immediately under the inlet air passage 61i. The bottom wall 64e1 and the inlet air passage 61i are superposed in a plane. The upper space 61a augments the volume of the downstream expansion chamber 61a. The downstream expansion chamber 61a having a large volume has a high silencing effect.

The main space 61a2 extending downward from the upper space 61a1 has a lower extension 61a3 extending downward below the level of the throttle device 70. The outlet air passage 610 opens into the main space 61a2 at a position below the upper space 61a1.

The entrance duct 66 and the inlet air passage 61i extend vertically. The exit duct 67 and the outlet air passage 61o extend horizontally. The inlet air passage 61i opens into the upper space 61a1 of the downstream expansion chamber 61a. The outlet air passage 61o is above the level of the bottom wall 63 of the downstream expansion chamber 61a.

As shown in FIGS. 2 and 3, a U-shaped water-stopping rib 19 rises from the top wall 6b into the air-intake space 40. The water-stopping rib 19 extends on the right, left and rear sides of the upstream end 51i1 of the inlet air passage 51i. The water-stopping rib 19 has a rear part 19a on the rear side of the upstream end 51i1, a right part 19c extending from the right end of the rear part 19a on the right side of the upstream end 51i1, and a left part 19b extending from the left end of the rear part 19a on the left side of the upstream end 51i1. A part of the top wall 6b on the front side of the upstream end 51i1 is bulged to form a bulged part 6e (FIG. 2) over the generator cover 9. As viewed in a plane, the upstream end 51i1 is surrounded by the bulged part 6e extending on the front side of the upstream end 51i1 and the water-stopping rib 19 extending on the right, left and rear sides of the upstream end 51i1.

The water-stopping rib 19 is provided with a drain hole, not shown, and the joining parts 53c defining cavities opening into the upstream expansion chamber 51a are provided with drain holes 59, respectively.

Referring to FIG. 4, the left part 64b of the side wall 64 is provided with a flat water-separating rib 68. The water-separating rib 68 projects from a position on the inside surface of the left part 64b between the lower extension 61a3 and the outlet air passage 61o. The water-separating rib 68 extends forward and rearward beyond the outlet air passage 61o and the throttle passage 71. A drain hole 69 is formed in or near the bottom wall 63.

The inlet air passage 51i is on the opposite side of the intake air exit, the inlet air passage 61i and the outlet air passage 61o with respect to the center axis Le. The inlet air passage 51i, outlet air passage 510 and the outlet air passage 61o are disposed so as to intersect a straight line La (FIG. 3) intersecting the inlet air passage 51i and the throttle passage 71 as viewed in a plane. The straight line La crosses the center axis Le and is parallel to the longitudinal direction as viewed in a plane.

Description will be made of the operation and effect of the outboard motor S of the present invention including the internal combustion engine E provided with the intake system N for carrying air for combustion into the combustion chambers formed in the engine body, the engine cover 6 forming the engine compartment 7 for holding the internal combustion engine E, and a top cover 17 covering the engine cover 6 from above. Intake air for combustion is taken in through the air-intake opening 41 formed outside the engine compartment 7. The upstream intake silencer 50 carries the intake air into the intake system N disposed in the engine compartment 7. The upstream intake silencer 50 is formed outside the engine compartment 7 and is spaced apart from the engine cover 6 so as to form the air-intake space 40 including the air-intake opening 40 over the top wall 6b of the engine cover 6. The upstream intake silencer 50 has the entrance duct 56 forming the inlet air passage 51i and separated from the top wall 6b, the wall structure 55 forming the upstream expansion chamber 51a into which the intake air flows through the inlet air passage 51i, and the exit duct 57 forming the outlet air passage 51o through which the intake air flows. The upstream end 51i1 of the inlet air passage 51i opens into the air-intake space 40 and is disposed on the rear side of the downstream end 51o2 of the outlet air passage 510 at the level higher than the air-intake opening 41. The entrance duct 56 does not project downward from the bottom wall 53 of the wall structure 55 and projects upward from the bottom wall 53 into the upstream expansion chamber 51a.

Pulsation of the intake air in the intake system N disposed in the engine compartment 7 is attenuated by the upstream intake silencer 50, and the upstream intake silencer 50 is separated upwardly from the engine cover 6 by the air-intake space 40. Therefore, transmission of the pulsation of the intake air from the intake system N to the air-intake space 40 is suppressed and hence intake noise generated by the vibration of the engine cover 6 underlying the air-intake space 40 can be reduced.

The upstream end 51i1 of the inlet air passage 51i of the upstream intake silencer 50 opening into the air-intake space 40 is on the rear side of the downstream end 51o2 of the exit duct 57, and hence the engine operator in front of the outboard motor is remote from the upstream end 51i1 of the inlet air passage 51i. Therefore, intake noise that leaks through the upstream end 51i1 of the entrance duct 56 is attenuated before reaching the engine operator.

The upstream end 51i1 of the inlet air passage 51i is at the level higher than that of the air-intake opening 41, and the entrance duct 56 is spaced apart from the top wall 6b. Therefore, restriction is reduced on the shape of the top wall 6b of the engine cover underlying the air-intake space 40 placed by the entrance duct 56 to ensure satisfactory draining from the air-intake space 40, and the degree of freedom of designing the top wall 6b increases. Since the entrance duct 56 projects upward into the upstream expansion chamber 51a, the upstream intake silencer 50 can be disposed close to the engine cover 6 with respect to the vertical direction and hence the outboard motor S can be formed in small vertical dimension.

The intake system N is provided with the downstream intake silencer 60 into which the intake air flows through the outlet air passage 51o. The downstream intake silencer 60 has the downstream expansion chamber 61a, the vertical inlet air passage 61i opening into the upper space 61a1 of the downstream expansion chamber 61a, and the lateral outlet air passage 61o at the level higher than that of the bottom wall 63. The downstream expansion chamber 61a has the lower extension 61a3 extending downward below the level of the outlet air passage 61o. The water-separating rib 68 projects laterally from the position between the lower extension 61a3 and the outlet air passage 61o. Since the downstream expansion chamber 61a has the lower extension 61a3 extending downward below the level of the outlet air passage 61o, water that flows into the downstream expansion chamber 61a together with the intake air flowing down into the downstream expansion chamber 61a flows by inertia into the lower extension 61a3 and adheres to the bottom wall 63. Thus, water that enters the downstream expansion chamber 61a sticks to the bottom wall 63, and the left part 64b of the side wall 64 is provided with the water-stopping rib 68. Therefore, water is restrained from flowing into the outlet air passage 61o.

The intake system N is provided with the throttle valve device 70 forming the throttle passage 71 connecting to the outlet air passage 61o. The inlet air passage 51i, the outlet air passage 51o and the outlet air passage 61o are disposed so as to intersect the straight line La intersecting the inlet air passage 51i and the throttle passage 71 as viewed in a plane. The inlet air passage 51i, the outlet air passage 51o, the inlet air passage 61i and the throttle passage 71 are arranged on a straight line as viewed in a plane. Therefore, the flow of the intake air from the inlet air passage 51i through the outlet air passage 51o and the inlet air passage 61i into the throttle passage 71, i.e., the flow of the intake air through the upstream intake silencer 50 and the downstream intake silencer 60, is restrained from meandering in lateral directions, and hence intake resistance is low and volumetric efficiency is high. Consequently, the output performance of the internal combustion engine E is high.

The air-intake opening 41 opens rearward at the rear end of the air-intake space 40. The rib 19 rises from the top wall 6b in the air-intake space 40 on the rear, right and left sides of the upstream end 51i1 of the inlet air passage 51i. Therefore water that enters the air-intake space 40 through a rear part of the air-intake opening 41 is restrained from entering the inlet air passage 51i through the upstream end 51i1 and is prevented from entering the upstream intake silencer 50.

The air-intake opening 41 is formed so as to surround the upstream intake silencer 50 or the upstream expansion chamber 51 from the right, left and rear sides of the upstream intake silencer 50 or the upstream expansion chamber 51 as viewed in a plane. Therefore, the air-intake opening is long and can be formed in the small width W, so that a necessary intake rate can be ensured and the entrance of foreign matters through the air-intake opening 41 into the air-intake space 40 can be prevented. Moreover, water that enters the air-intake space 40 is drained from the air-intake space 40 in lateral directions and hence water is restrained from flowing through the inlet air passage 51i into the upstream intake silencer 50.

Changes that can be made to the foregoing embodiment to provide modifications will be described.

Although the top cover 17 is a part of the upstream intake silencer 50 in the foregoing embodiment, the same part of the upstream intake silencer 50 maybe formed of a separate member. The upstream end 51o1 of the outlet air passage 510 may open upward.

The rear end of the air-intake space 40 may be closed without forming the air-intake opening 41 in the rear end of the air-intake space 40. When the rear end of the air-intake space 40 is closed, air for combustion is taken into the air-intake space 40 through parts of the air-intake opening 41 longitudinally extending on the right and left sides, respectively, of the inlet pair passage 51i and the outlet air passage 51o.

The internal combustion engine E is not limited to the four-cylinder internal combustion engine and may be a multiple-cylinder internal combustion engine other than the four-cylinder internal combustion engine or a single-cylinder internal combustion engine.

1. An outboard motor comprising:
an internal combustion engine);
an intake system for carrying intake air for combustion into a combustion chamber formed in the internal combustion engine;
an engine cover forming an engine compartment for enclosing the internal combustion engine; and
a top cover covering the engine cover from above:
wherein the outboard motor includes an air-intake opening formed outside the engine compartment, and an intake silencer for carrying intake air taken in through the air-intake opening into the intake system, the intake system being disposed within the engine compartment;
wherein the intake silencer is disposed outside the engine compartment, is spaced apart from the engine cover such that an air-intake space connecting to the air-intake opening is formed between a top wall of the engine cover and the intake silencer; and
the intake silencer has an entrance duct spaced apart from the top wall and having an upstream end through which intake air flows from the air-intake space into the entrance duct, a wall structure defining an expansion chamber into which intake air flows through the inlet air passage, and an exit duct forming an outlet air passage through which intake air flows from the expansion chamber into the intake system; and
wherein the inlet air passage has an upstream end opening into the air-intake space, and is on a rear side of a downstream end of the outlet air passage and at a level higher than that of the air-intake opening; and
the entrance duct does not extend downward from a bottom wall included in the wall structure defining the expansion chamber and extends upward from the bottom wall in the expansion chamber.

2. The outboard motor according to claim 1, wherein the intake system includes a downstream intake silencer into which intake air flows through the outlet air passage of the exit duct;
the downstream intake silencer has a downstream expansion chamber, a vertically extending inlet air passage opening into an upper part of the downstream expansion chamber, and a horizontally extending outlet air passage formed above a bottom wall forming the downstream expansion chamber;
the downstream expansion chamber has a lower extension extending to a level below that of the outlet air passage; and
a horizontal water-stopping rib is disposed between the lower extension and the outlet air passage.

3. The outboard motor according to claim 1, wherein the intake system is provided with a throttle valve device forming a throttle passage connecting to the outlet air passage; and
the inlet air passage, the outlet air passage and the outlet air passage are extended so as to intersect a straight line intersecting the inlet air passage and the throttle passage in a plane.

4. The outboard motor according to claim 1, wherein the air-intake opening opens rearward at a rear end of the air-intake space; and
a rib is formed on the top wall so as to protrude upward from the top wall in the air-intake space and to extend on right, left and rear sides of the upstream end of the inlet air passage.

5. The outboard motor according to claim 1, wherein the air-intake opening extends on right, left and rear sides of the upstream intake silencer.
